(19) United States
(12) Patent Application Publication
(10) Pub. No.: US 2026/0266131 A1
(43) Pub. Date: Sep. 10, 2026

(54) MOTORIZED WINDOW COVERING ARRANGEMENT

(71) Applicants: Klondike59, Inc., Park City, UT (US); Dendo Systems Pty Ltd., Truganina (AU)

(72) Inventors: Andrew E. EINAUDI, Scotts Valley, CA (US); Alex LIU, Williams Landing (AU); Yi LIU, Truganina (AU)

(21) Appl. No.: 19/562,369

(22) Filed: Mar. 10, 2026

Related U.S. Application Data
(60) Provisional application No. 63/769,484, filed on Mar. 10, 2025.

(51) Int. Cl. E06B 9/322; E06B 9/24; E06B 9/262

(52) U.S. Cl. CPC E06B 9/322; E06B 9/262; E06B 2009/2476; E06B 2009/2627; E06B 2009/3222

(57) ABSTRACT

A snap on window covering is described. The window covering includes a first rail, a second rail, and a fabric that couples the first and second rails. The first rail includes a clip interface configured to enable attachment to a tension rod configured to be mounted between opposing first and second side jambs of an interior window frame. In another aspect, a window shade system includes the window covering. A motorized window covering that uses a headrail is also described. In an aspect, the motorized window covering comprises a headrail type motorized window covering with a battery unit. The battery unit includes a housing, a battery pack, an input coupling for a central drive shaft of the headrail, and an output coupling for the central drive shaft of the headrail. In another aspect, the motorized window covering comprises a microcontroller configured to perform various operations of the motorized window covering.

### CROSS-REFERENCE TO RELATED APPLICATIONS

This application claims priority to U.S. Provisional Patent Application No. 63/769,484, filed on Mar. 10, 2025, titled “Motorized Window Covering Arrangement,” the entirety of which is incorporated by reference herein.

### BACKGROUND

Window shades are an effective way to provide privacy, block out light and heat or insulate from heat loss. Despite there being some standard sizes for windows, the window boxes, window moldings and window openings that windows sit inside have a lot of variation in size and dimension. Therefore, the fabric to cover a window often requires a custom width to perform the job of adequately blocking the light or looking proper aesthetically-especially for blackout shades. Custom shade rods and fabric widths are either trimmed in factory, in-store at large cutting machines or at home with hacksaws and scissors which is prone to errors and/or injury.

Buildings consume 36% of global energy and nearly three-quarters of that energy is spent on heating and cooling. Typically, the number one source of energy loss in buildings is windows. Window coverings such as roller shades, cellular shades, zebra blinds, horizontal blinds and others can be an effective way to reduce energy waste. However, according to a Lawrence Berkeley Lab study, the most common type of window coverings, those which are manually operated, have on average no effect on heating & cooling consumption versus windows without coverings. Dynamic automated shading can make a real difference, though, by adjusting to changing conditions and optimizing energy use, thereby reducing energy waste.

Typical dynamic shading systems rely on sensors such as light, heat, humidity, user occupancy and others to make decisions about when to raise or lower a window treatment for maximum benefit. Most often, these sensors are maintained separately and/or battery powered such that installation, maintenance, communication, and power failures can hinder optimum operation of the dynamic shading system.

Motorized window coverings are desirable for their added convenience as well as child safety factor. Furthermore, battery operated motorized window coverings are increasingly popular thanks to the ease of installation without the need for electrical wiring work.

With certain types of motorized window coverings, a headrail which contains a drive shaft and plurality of reels for winding and unwinding strings to lift the window covering fabric are incorporated. With some types of headrail type window covering, finding the space to install a battery pack is problematic due to the drive rod extending along the entire length of the headrail. Existing designs typically have the battery pack mounted outside of the headrail entirely. Such a design, however, is less desirable from both an aesthetic and ease-of-use perspective.

Thus, a need therefore exists for a headrail type motorized window covering, with the battery pack installed inside the headrail.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Systems, methods, and apparatuses are described herein for a motorized window covering that uses a headrail. In an aspect, the motorized window covering comprises a headrail type motorized window covering with a battery unit. The battery unit includes a housing, a battery pack, an input coupling for a central drive shaft of the headrail, and an output coupling for the central drive shaft of the headrail.

In another aspect, an intermediate drive shaft is positioned between and mechanically connects the input coupling and the output coupling. In another aspect, the intermediate drive shaft has a center of rotation that is offset from that of the input and output couplings.

Systems, methods, and apparatuses are also described herein for a snap on window covering. In an aspect, the window covering includes a first rail, a second rail, and a fabric that couples the first and second rails. The first rail includes a clip interface configured to enable attachment to a tension rod configured to be mounted between opposing first and second side jambs of an interior window frame.

In another aspect, a window shade system includes the window covering and may further include the tension rod.

In still another aspect, a method for configuring a window shade system is provided. The method includes mounting a tension rod between opposing first and second side jambs of an interior window frame, cutting to a shorter width a window covering having a first rail, a second rail, and a fabric that couples the first and second rails, and clipping the cut window covering to the tension rod by a clip interface of the cut window covering.

Further features and advantages of the embodiments, as well as the structure and operation of various embodiments, are described in detail below with reference to the accompanying drawings. It is noted that the claimed subject matter is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the application and, together with the description, further serve to explain the principles of the embodiment and to enable a person skilled in the relevant art(s) to make and use the embodiments.

FIG. 1 depicts an interior window frame in detail indicating common naming conventions for window frame components.

FIG. 2a depicts an inside mounted window covering in a completely open state. In the case of a “distributed smart rail system”, this is also considered to be the docking position when the smart rail can charge to the window covering's rechargeable motor battery due to its proximity to the bracket 110 and dongle interface 202.

FIG. 2b depicts an inside mounted window covering in a partially open/closed state. In the case of a “distributed smart rail system”, this is also considered to be the non-docking position when the smart rail is unable to charge to the window covering's rechargeable motor battery due to its loss of proximity to the bracket 110 and dongle interface 202.

FIG. 2c depicts an inside mounted window covering in a completely closed state. In the case of a “distributed smart rail system”, this is also considered to be the non-docking position when the smart rail is unable to charge to the window covering's rechargeable motor battery due to its loss of proximity to the bracket 110 and dongle interface 202.

FIG. 3a depicts a tension rod, according to an embodiment.

FIG. 3b depicts a perspective view of a tension rod, according to another embodiment.

FIG. 4a depicts a cross-sectional end view of a window covering, according to an embodiment.

FIG. 4b depicts top edge and top perspective views of the window covering shown in FIG. 4a in an open position, according to an embodiment.

FIG. 4c depicts an inner perspective view of a closed window covering, according to the embodiment.

FIG. 4d depicts an outer perspective view of a closed window covering shown in FIG. 4c.

FIG. 4e depicts a side view of the open window covering shown in FIG. 4b.

FIG. 4f depicts side views of the open window covering shown in FIG. 4b and FIG. 4e prior to clipping to a tension rod and after clipping to the tension rod, according to embodiments.

FIG. 4g depicts perspective views of cutting mechanism in position to cut first and second ends of a window covering, respectively, according to embodiments.

FIG. 4h depicts side views of the open window covering shown in FIG. 4g prior to and after having first and ends removed.

FIG. 4i depicts a perspective view of an open window covering similar to that shown in FIG. 4f with end caps being attached, according to an embodiment.

FIG. 4j depicts perspective views of an open window covering similar to that shown in FIG. 4f with a solar panel being attached and a coded badge being attached, respectively.

FIG. 4k depicts a user interface device capable of setting a bottom limit for a window covering, that can be used for any embodiment.

FIG. 5 depicts a smart rail microcontroller with labeled inputs/outputs for decision making and control operation of a microcontroller of a window covering system, that can be used for any embodiment.

FIG. 6 depicts a headrail arrangement with a motor and a battery unit, according to embodiments.

FIG. 7 depicts another view of the headrail arrangement with a motor and a battery unit, according to embodiments.

FIG. 8 depicts a view of a battery unit in isolation, according to embodiments.

FIG. 9 depicts an exploded view of the battery unit, according to embodiments.

FIG. 10 depicts an exploded view of a geared endcap, according to embodiments.

FIG. 11 depicts a microcontroller that can be used for any embodiment.

The features and advantages of the embodiments described herein will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description discloses numerous example embodiments. The scope of the present patent application is not limited to the disclosed embodiments but also encompasses combinations of the disclosed embodiments, as well as modifications to the disclosed embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of persons skilled in the relevant art(s) to implement such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures and drawings described herein can be spatially arranged in any orientation or manner. Additionally, the drawings may not be provided to scale, and orientations or organization of elements of the drawings may vary in embodiments.

As used herein, the term “window covering” refers to a window shade or window blind configured to screen a window thereby achieving similar results to those obtained by fitting curtains, including reducing an amount of light incoming through the window into a room. A window covering is typically sized to substantially the same width and height as the window to which it is applied. Window blinds may have varying thermal effects, such as blocking unwanted heat of the sun in warmer weather and maintain room heat in colder weather. A window covering may also provide privacy to a room from outside onlookers.

A “motorized window covering” comprises a window covering that is movable (e.g., between different position, such as open, partially open, closed, or partially closed) or otherwise operable through an electronic drive unit. An “electronic drive unit” comprises a device (e.g., a motor) that converts electrical energy into a mechanical force, such as a rotational or linear force. An electronic drive unit obtains electrical energy from a power source, which can be a hardwired power source (e.g., an outlet) or a battery pack. A “battery pack” as used herein is a device that stores electrical energy using one or more cells.

As used herein, the term “fabric” refers to the screening material of a window covering. The fabric may be rolled up or configured accordion style. Example materials of the fabric include cotton, polyester, wool, viscose, and silk.

As used herein, the term “interior window frame” refers to the side of a window frame interior to a dwelling (e.g., a room, a home, an office, a retail space, etc.) for a window frame affixed in a wall of the dwelling. The term “inside mount window covering” refers to a window covering mounted within a window frame. The term “outside mount window covering” refers to a window covering mounted to or outside the window frame, such as being mounted to the wall above the window frame or the head casing of the window frame. The term “outside facing view,” when used with respect a smart rail, refers to a side of the smart view that faces toward the exterior of a dwelling (e.g., through the window) when affixed to a window covering as described herein. The term “inside facing view,” when used with respect a smart rail, refers to a side of the smart view that faces toward the interior of a dwelling when affixed to a window covering as described herein. The term “completely open” with reference to a window covering refers to the window covering being fully retracted. In a completely open position, light may pass through substantially the entire window (e.g., the glass panes) associated with the window covering without being impeded by the window covering. The term “completely closed” with reference to a window covering refers to the window covering being fully extended. In a completely closed position, light is impeded from passing through substantially all of the associated window.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments for Snap on Window Covering

Window coverings are an effective way to block out light and heat or insulate from heat loss and save energy. Dynamic shade systems maximize savings by using sensor data to make intelligent decisions. However, most commonly these sensor systems, microcontrollers and power systems have been separated which leads to high cost, installation, maintenance and troubleshooting problems. Furthermore, despite there being standard sizes for windows, the windows boxes, window moldings and window openings that windows sit inside have a lot of variation in size and dimension. The fabric to cover a window often requires a custom width to adequately block incoming light or to appear proper aesthetically-especially for blackout shades. Custom shade rods and fabric widths are either trimmed in factory, in-store at large cutting machines or at home with hacksaws and scissors which is prone to errors and/or injury. Furthermore, the process of assembling a window covering to be applied to a window frame is unwieldy.

Embodiments disclosed herein overcome these issues. In particular, a snap on window covering is disclosed herein that is easily sized for a window frame and easily mounted to the window frame. A mounting rod (also known as “mounting bar”) such as a tension rod (also known as “tension bar”) may be installed in a window frame. The tension rod is a horizontally extending rod (e.g., with circular or rectangular cross-section) that adheres in place in a window frame at least due to a horizontal outward force applied by the tension rod against opposing surfaces (e.g., side jambs) of the window frame. In an embodiment, the mounting rod includes a measurement mechanism, such as one or more measurement indications, that may be read to determine a current width of the tension rod mounted in place. A snap on window covering may then be cut to match the determined width of the tension rod. Furthermore, the snap on window covering includes a clip interface that is configured to clip onto the tension rod such that it hangs in place over the window of the window frame. In this manner, the window covering is easily configured and installed, and provides its shading functionality to the window. These and further benefits of the disclosed embodiments are described as follows.

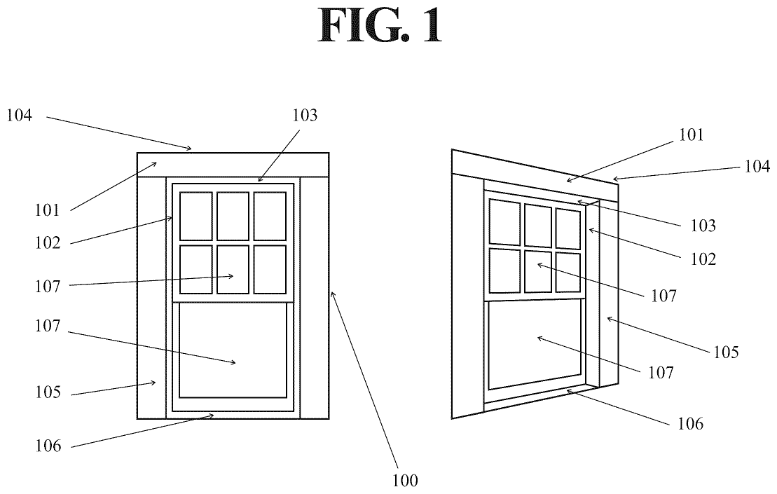

In particular, FIG. 1 depicts an interior window frame in detail comprising a head casing 101, first and second side jamb extensions 102 (also referred to as first and second side jams), a head jamb extension 103, a side casing 105, windowsill (“sill”) 106, and glass panes 107 combining to create the window 100 structure and surrounded by wall 104 area. Head casing 101, side jamb extension 102, head jamb extension 103, wall 104, and in some cases side casing 105, all provide suitable mounting locations for window coverings. The sill 106 is often the logical limit for inside mount window coverings which will be discussed later.

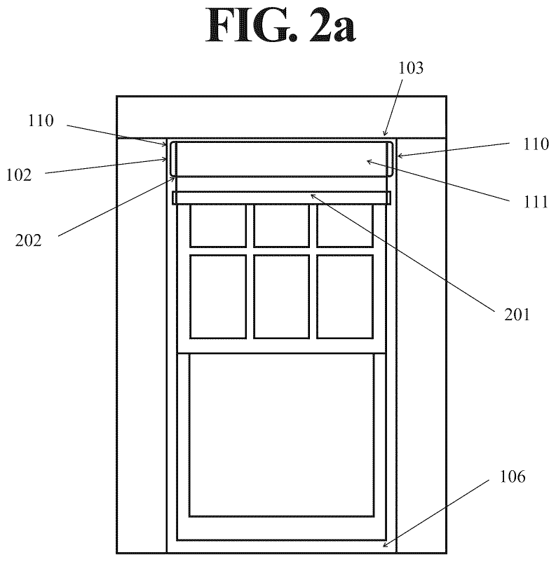

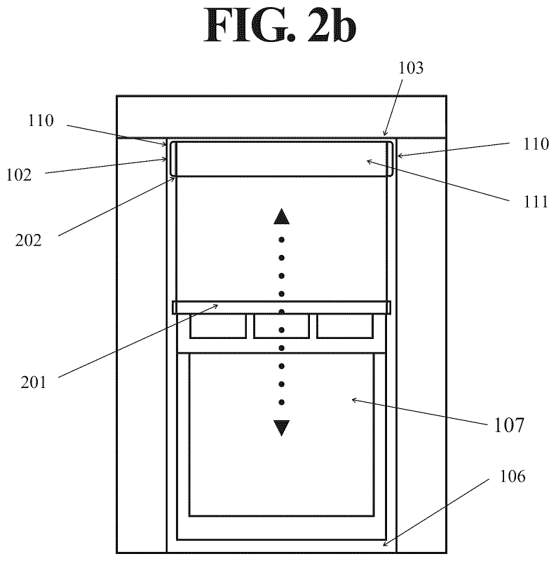

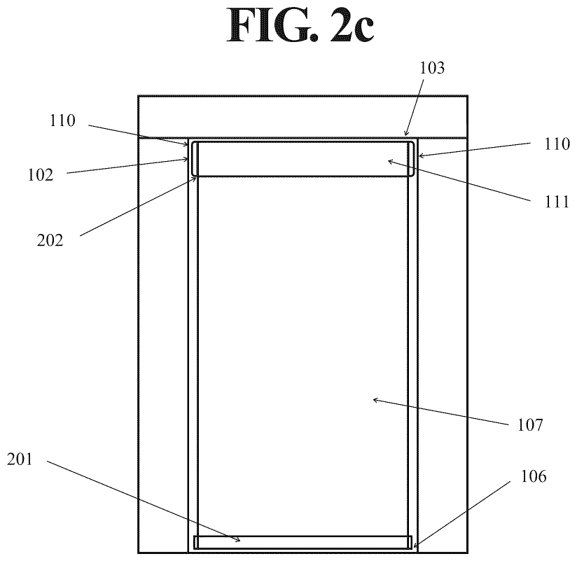

FIG. 2a illustrates an inside mount window covering applied to the interior window frame of FIG. 1, according to an example embodiment. As shown in FIG. 2a, the inside mount window covering includes a top (or “head”) rail 111 and a bottom rail 201. In examples, a top rail or head rail type window covering comprises a window shade or window blind that is mounted to an upper portion of an interior window frame, such as on or near head casing 101, head jamb extension 103, or an upper portion of side jamb extension 102 or side casing 105. Top rail 111 is connected between side jamb extensions 102 at first and second mount positions 110. In this open position, the bottom rail 201 outside facing sensors and/or solar panel may be partially or completely unable to collect data and/or solar charge but inside facing sensors will work.

FIG. 2b illustrates the inside mount window of FIG. 2a in a partially opened/closed position, where bottom rail 201 is partially lowered between head jamb extension 103 and sill 106 of the interior window frame. Outside facing sensors and/or solar panel should be able to optimize position to collect data and/or solar charge and inside facing sensors will continue to work well.

FIG. 2c illustrates the inside mounted window covering of FIGS. 2a and 2b completely closed. In this closed position, the bottom rail 201 outside facing sensors and/or solar panel may be partially or completely unable to collect data and/or solar charge but inside facing sensors will work, depending on the height of the sill 106 relative to the opening of the glass panes 107. It is worth noting that inside mount window coverings often achieve the best insulative properties compared to other mounting methods. In the case of a very tight fit and good seal, comparing the inside and outside sensor readings may provide a powerful tool to determine the exact insulative value of the window covering.

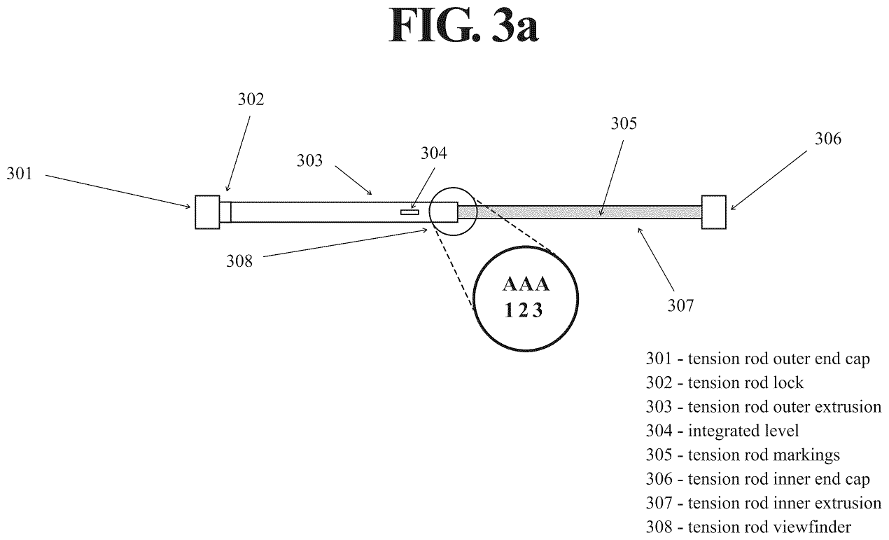

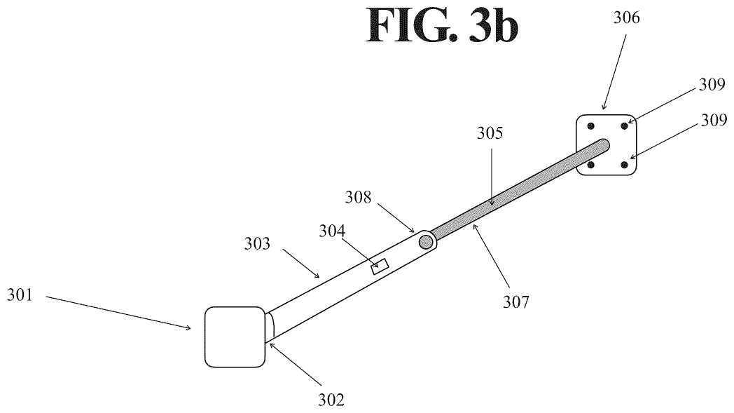

FIG. 3a depicts a tension rod, according to an embodiment. As shown in FIG. 3a, the tension rod includes a tension rod outer end cap 301, a tension rod lock 302, a tension rod outer extrusion 303, an integrated level 304, one or more tension rod markings 305, a tension rod inner end cap 306, a tension rod inner extrusion 307, and a tension rod viewfinder 308. One or more of these features may be present in tension rod embodiments. These features of the tension rod are described as follows.

As shown in FIG. 3a, outer extrusion 303 fits over at least a portion of inner extrusion 307 to form the length of the tension rod. Inner extrusion 307 may adjustably slide in and out of outer extrusion 303 to change an overall length of the tension rod. Outer end cap 301 is coupled (e.g., fitted over) an end of outer extrusion 303, and inner end cap 306 is coupled (e.g., fitted over) an end of inner extrusion 307. Outer and inner end caps 301 and 306 interface the tension rod with respective mounting positions (e.g., opposing jambs of a window frame), and have mounting surface sizes configured to stably mount the tension rod in the window frame.

Tension rod lock 302 is a locking mechanism that locks the tension rod at a length selected by sliding outer and inner extrusions 303 and 307 relative to each other, thereby enabling the tension rod to be locked in the retracted position or expanded position. For instance, tension rod lock 302 may be a threaded screw interface which when fully tightened activates the interior spring of the tension rod to achieve maximum spring force to hold tension rod in place.

Integrated level 304 is a level device mounted to/in the tension rod that is configured to indicate (to a user) an orientation of the tension rod relative to horizontal. For instance, integrated level 304 may be a bubble level that is a tube filled, incompletely, with a liquid, such as a colored spirit or alcohol, thereby leaving a bubble in the tube. A bubble level has a slight upward curve, so that the bubble naturally rests in the tube center, the highest point. At slight inclinations the bubble travels away from the marked center position. In other embodiments, other types of integrated level 304 may be present.

Markings 305 are measurement indications configured to indicate a distance between the first and second side jambs (also, between the opposing mounting surfaces of end caps 301 and 306) between which the tension rod is mounted. The measurement indications may include one or more of marking lines, one or more colors, and/or one or more alphanumeric characters that indicate/correspond to distances in centimeters, inches, feet, etc.).

Viewfinder 308 is configured to provide a measurement of the length of the tension rod in a retracted or expanded position. For instance, in an embodiment, viewfinder 308 may be a tinted lens area overlaid the number section of the markings 305 or viewfinder 308 may be printed arrows clearly indicating where to make a reading on markings 305.

FIG. 3b depicts a perspective view of the tension rod of FIG. 3a, according to an embodiment. As shown in FIG. 3b, one or both of end caps 301 and 306 may include one or more screw holes 309. Screw holes 309 enable the securing of the mounting of the tension rod to the first and second opposing surfaces (e.g., window frame side jambs) by corresponding screws.

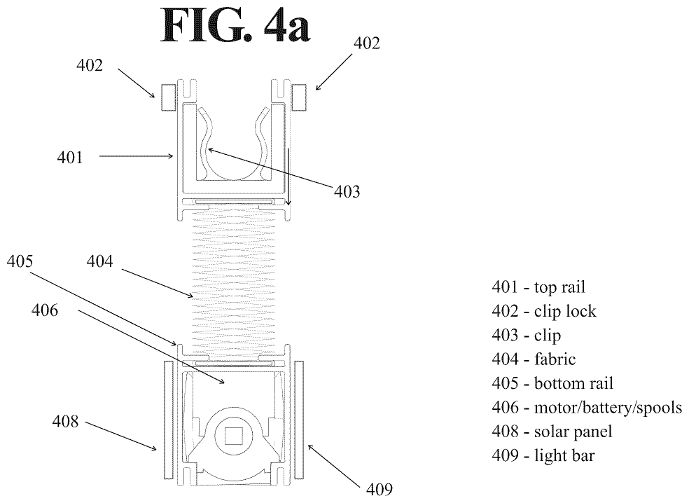

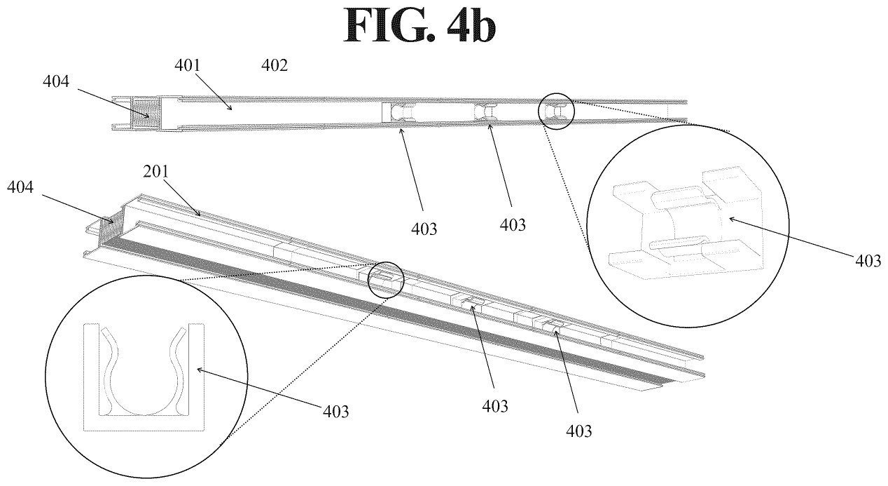

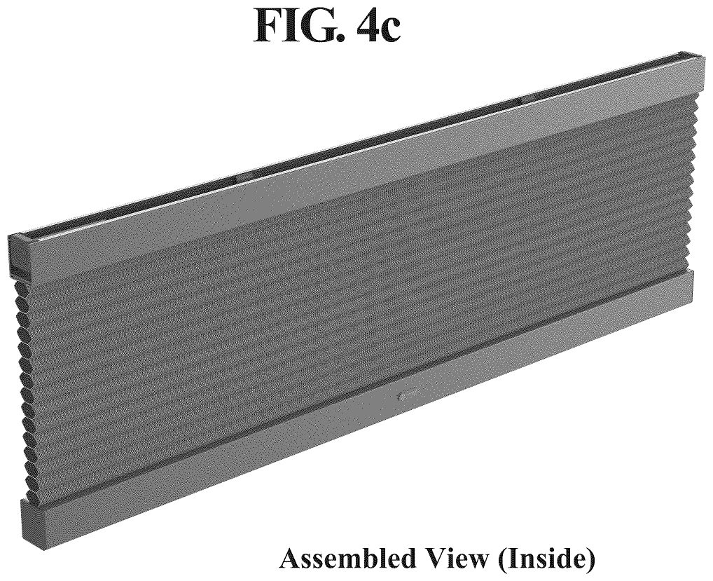

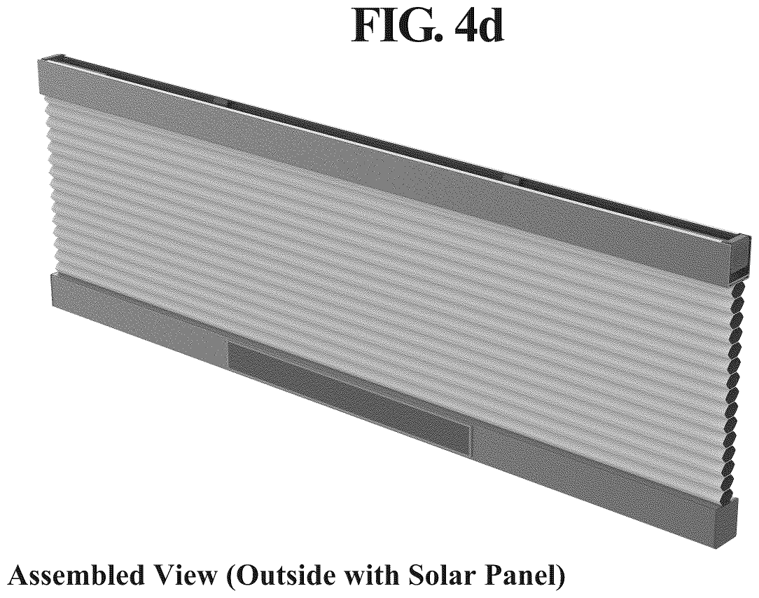

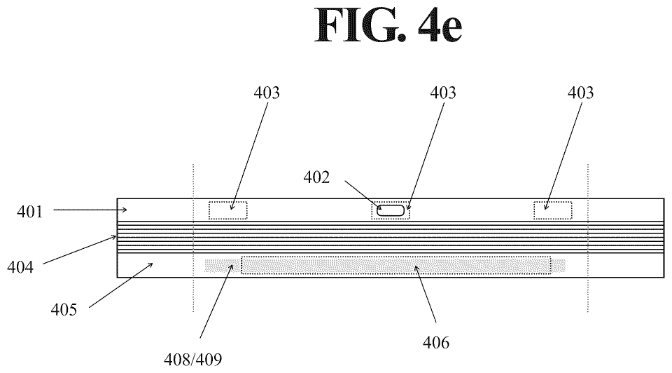

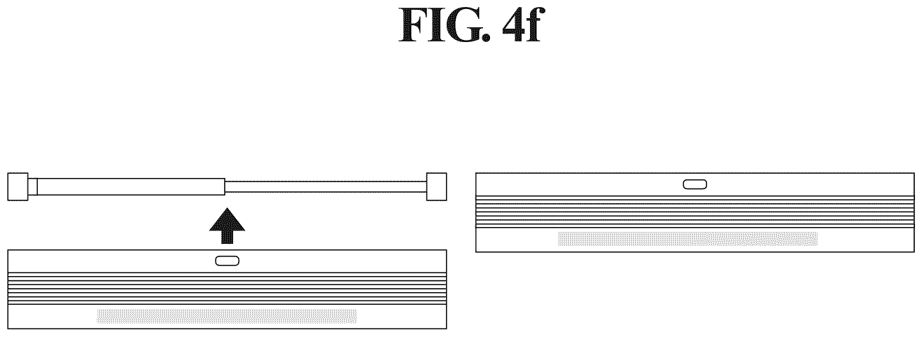

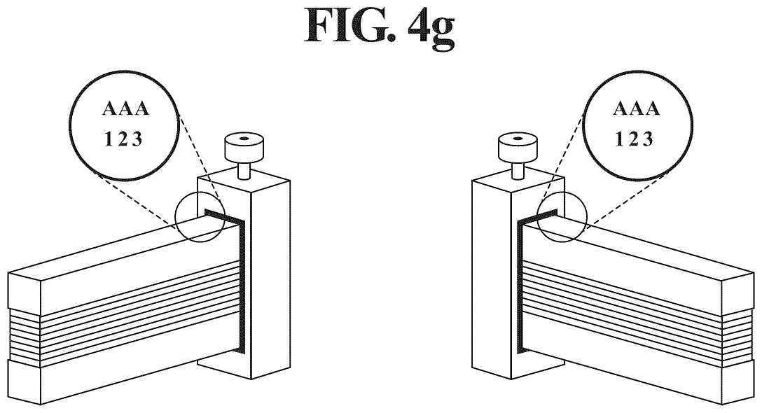

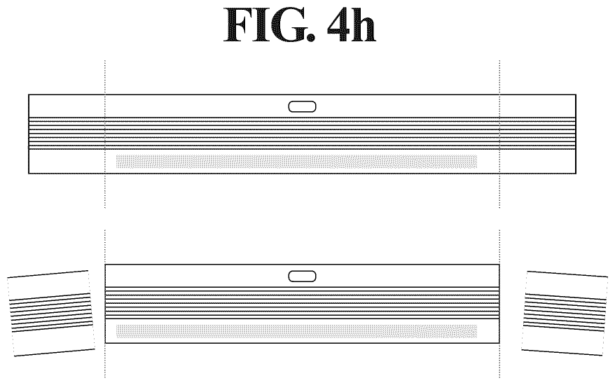

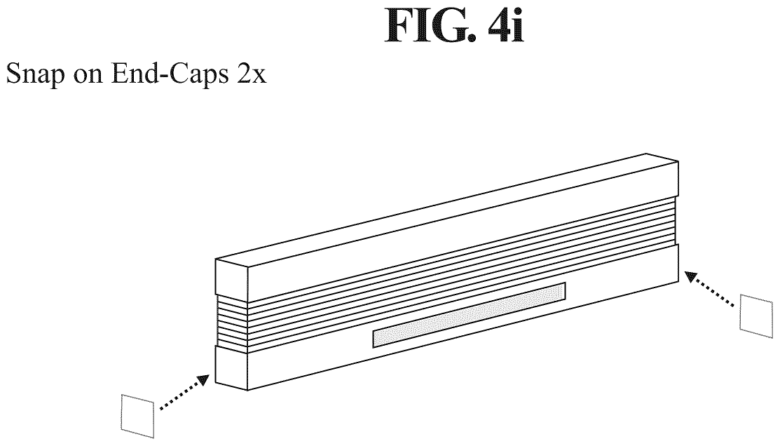

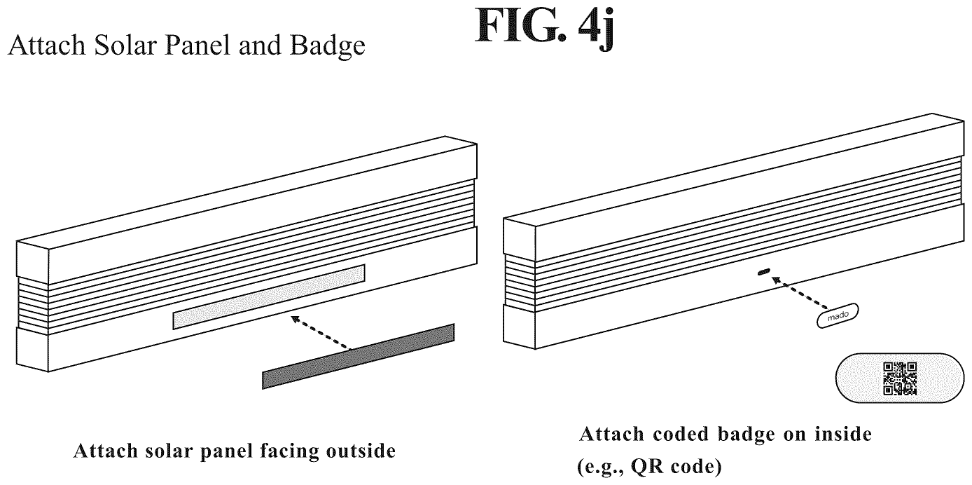

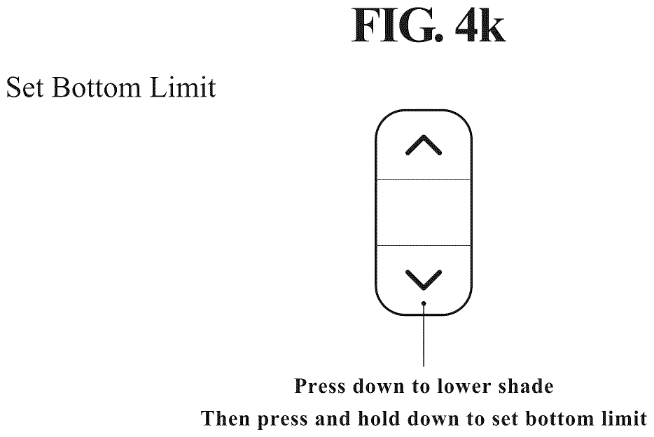

According to embodiments, a window covering may be attached to the tension rod of FIGS. 3a and 3b when the tension rod is installed in a window frame. For instance, FIGS. 4a-4e show varying views of example window coverings that may be attached to a tension rod, in embodiments. FIGS. 4a-4e are described as follows.

For example, FIG. 4a depicts a cross-sectional side end of a window covering, according to an embodiment. As shown in FIG. 4a, the window covering includes a top (first) rail 401, a clip lock 402, a clip 403, a fabric 404, a bottom (second) rail 405, a motor/battery/spools 406, a solar panel 408, and a light bar 409. These features of the window covering of FIG. 4a are further described as follows.

The window covering of FIG. 4a generally includes top rail 401 and bottom rail 405 coupled together by fabric 404 therebetween. Top rail 401 and bottom rail 405 are generally elongated structures (e.g., made of metal, plastic, etc.) that provide rigid structure along the top and bottom edges of the window covering.

In the example of FIG. 4a, fabric 404 is configured accordion style (also known as pleated shades/blinds or cellular shades/blinds) such that fabric 404 includes a series of collapsable, air-filled structures, or cells, that may be expanded or collapsed (opened or folded into themselves) by correspondingly increasing or decreasing the distance between top and bottom rails 401 and 405 (opening or closing the window covering), thereby allowing the window covering to cover more or less of the window against which the window covering is applied.

One or more additional components (e.g., a motor, one or more clips, a battery, a solar panel, a light) may be included in one or both of top and bottom rails 401 and 405 to provide further functionality to the window covering. For example, as shown in FIG. 4a, bottom rail 405 may include one or more of a motor/battery/spools 406. A motor, when present, enables the automatic opening and closing of the window covering, as controlled by a user interface such a push button, a draw string/rod, an application in an electronic device (e.g., a smart phone, a virtual assistant, etc.). A battery (rechargeable or disposable) when present, may store energy for use by the motor, a processor of the window covering, a light of window covering (e.g., light bar 409), and/or other electrical feature of the window covering.

Solar panel 408 is configured to convert received light (e.g., sunlight) to electricity that is stored in a rechargeable battery of top rail 401 and/or bottom rail 405. For instance, solar panel 408 may be installed on/in a surface of a rail that faces outside of a room, such as toward the sun, to receive light and generate electricity therefrom for storage in the rechargeable battery. Solar panel 408 may include any suitable type and number of solar cells, as would be known to persons skilled in the relevant art(s).

Light bar 409, when present, is a light emitter powered by the battery. Light bar 409 is configured to illuminate fabric 404 to simulate one or more of lighting internal to a dwelling (e.g., a standing lamp, a desk light, an overhead light), activity in the dwelling (motion of persons relative to light sources), or media playback (e.g., light emitted from a television or computer screen) in the dwelling. In this manner, light bar 409 can provide enhanced security for the dwelling by giving the appearance the dwelling is currently occupied, even if there are no occupants present. Light bar 409 may include one or more of any suitable type of light emitters/sources, including light emitting diodes (LEDs), liquid crystal displays (LCDs), incandescent lights, etc. LEDs and LCDs may be manufactured for small size convenient for attachment to a rail.

As shown in FIG. 4a, the window covering includes one or more clips 403 and one or more clip locks 402. A clip 403 is a clip interface configured to enable attachment of top rail 401 of the window covering to a tension rod mounted to an interior window frame. For instance, as shown in FIG. 4a, clip 403 may have a circular cross section (receptacle) for receiving a tension rod having a circular cross section. Clip 403 may be made of metal, carbon fiber, plastic or any strong material that can flex and hold weight. Clip 403 may also be coated in rubber or plastic to ensure good fit. Clip 403 has a gap at top of top rail 401 through which the tension rod may pass to be fitted into the circular receptacle of clip 403. First and second end portions of clip 403 may be spaced apart by a width less than a cross-sectional width of the tension rod, may spread apart when the tension rod passes between them, and then may pinch/spring back to their original spacing, or close thereto, to hold the tension rod in place in clip 403.

Furthermore, clip lock 402 is a clip locking mechanism that may be present. When present, clip lock 402 may be actuated to further lock the tension rod in the receptacle of clip 403. In one example, clip lock 402 may be achieved by inserting a pin into the top rail 401 above the clip to prevent the top rail from failing if clip 403 should fail. Clip lock 402 may also be achieved by a sliding mechanism which prevents the clip from being able to open after the tension rod has been installed keeping the tension rod clipped in place.

FIG. 4b depicts top edge and top perspective views of the window covering of FIG. 4a in open positions, according to embodiments. As shown in both views of FIG. 4b, three clips 403 are included in top rail 401 to coupling with a tension rod to which the window covering is affixed. In embodiments, any number of clips 403 may be present, such as one, two, five, ten, etc., and such clips may have any suitable width. For instance, a single clip may be present that has a width substantially equal to the width of top rail 401. A first inset image in FIG. 4b shows an example cross-sectional view of a clip 403, and a second inset image in FIG. 4b shows a perspective view of an example clip 403, which has a clip segment (for clipping to a tension rod) positioned between bracket segments (e.g., for attachment to top rail 401, such as by one or more screws, an adhesive, etc.).

FIG. 4c depicts an inner perspective view of the window covering of FIG. 4a, according to an embodiment. In FIG. 4c, the inner side (facing into the dwelling) of the window covering is shown, and the window covering is in an at least partially closed (or partially open) configuration (e.g., the fabric is expanded).

FIG. 4d depicts an outer perspective view of the window covering of FIG. 4a, according to an embodiment. In FIG. 4d, the outer side (facing out of the dwelling, through the window) of the window covering is shown, and the window covering is in an at least partially closed or partially open configuration (e.g., the fabric is expanded). Furthermore, an example solar panel attached to the bottom rail is shown.

FIG. 4e depicts a cross-sectional side view of the open window covering of FIG. 4a, according to an embodiment. As shown in FIG. 4e, the window covering includes top rail 401, a clip lock 402, three clips 403, fabric 404, bottom rail 405, motor/battery/spools 406, solar panel 408, and light bar 409.

Accordingly, the window covering of FIGS. 4a-4e may be configured and connected to the tension rod of FIGS. 3a and 3b to form a window shade system mounted in a window frame to provide shading and corresponding functionality, as described herein. An example of such a process is described as follows with respect to FIGS. 4f-4k.

In a first step, a tension rod is mounted between opposing first and second side jambs of an interior window frame. For instance, the tension rod of FIGS. 3a-3b may be mounted between the first and second opposing side jamb extensions 102 of the window frame of FIGS. 1 and 2a-2c. The tension rod may be expanded to fit the gap between side jambs by extending the outer and inner extrusions 303 and 307 relative to each other, which forces end caps 301 and 306 against the opposing extensions 102, and then locking the tension rod length using tension rod lock 302 (in the expanded position). The tension rod may then be left in place.

During and/or after the mounting, a level indication may be provided by integrated level 304, which may be used by an installer to make sure tension rod is set in a suitably accurate horizontal orientation. A measurement of the length of the tension rod in a retracted or expanded position may be provided by viewfinder 308. The mounting to the first and second side jamb extensions 102 may be further secured at screw holes 309 of the tension rod by corresponding screws.

In a further step, the window covering is clipped to the tension rod by a clip interface of the cut window covering. For instance, FIG. 4f depicts side views of an open window covering prior to clipping to a tension rod and after clipping to the tension rod, according to embodiments. As shown in the left side of FIG. 4f, the top rail of the window covering is moved toward the mounted tension rod. As shown in the right side of FIG. 4f, the top rail of the window covering is clipped to the tension rod, thereby hiding the tension rod from view. In this manner, a mounted window shade system is formed that is easy and convenient to clip into place due to the inclusion of the clipping mechanism (e.g., clips) of the top rail of the window covering.

Note that in an intermediate step, the window covering may be cut to a shorter width in order to fit into the window frame. Such cutting entails cutting one or both ends from the window covering (thereby cutting off a portion(s) of top rail 401, bottom rail 405, and fabric 404). To perform this step, a width of the mounted tension rod may be determined using viewfinder 308 and/or markings 305 (measurement indications) of the mounted tension rod. The window covering may be cut to have a width equal to this determined width through the use of a cutting mechanism.

For instance, FIG. 4g depicts perspective views of a cutting mechanism in position to cut first and second ends of a window covering, respectively, according to embodiments. An end of the window covering may be locked in place by a locking mechanism of the fabric cutting mechanism. The window covering is locked into place so that the fabric cutting mechanism cuts the window covering at positions (e.g., at each end) to have an overall width remaining that matches the determined width of the tension rod. Movement of a blade of the fabric cutting mechanism into and through the window covering is enabled, such as by a push button or buttons that can be located on top or sides of cutting of the fabric cutting mechanism or by twisting a threaded screw, to cut an end from the window covering. This may be repeated for both ends of the window covering (e.g., for symmetry purposes).

FIG. 4h depicts side views of the open window covering of FIG. 4a prior to and after having first and ends removed, according to an embodiment. In this manner, the window covering has a configured width substantially matching that of the mounted tension rod. Thereafter, the cut window covering may be attached to the mounted tension rod, as shown in FIG. 4f.

Further steps may be performed. For instance, FIG. 4i depicts a perspective view of an open window covering with end caps being attached, according to an embodiment. As shown in FIG. 4i, end caps are snapped onto the cut ends of the bottom rail of the cut window covering. In this manner, a smooth surface is provided at the cut ends (rather than the interior of the cut bottom rail being exposed). In another embodiment, end caps may similarly be applied to the top rail of the cut window covering.

Furthermore, FIG. 4j depicts perspective views of an open window covering with a solar panel being attached and a coded badge being attached, respectively, according to an embodiment. As shown in FIG. 4j, one or both of a solar panel (e.g., solar panel 408 of FIG. 4a) or a coded badge are mounted to the bottom rail of the window covering. The coded badge may include a code (e.g., alphanumeric, bar code, QR code) that uniquely identifies the window covering for tracking purposes. In another step, a light emitter (e.g., light bar 409 of FIG. 4a) may be similarly attached to the bottom rail (inner side) of the window covering.

As described herein, a user interface may be provided that enables configuration and usage of a mounted window shade system. For instance, FIG. 4k depicts a user interface device capable of setting a bottom limit for a window covering, according to an embodiment. In the example of FIG. 4k, a down arrow of the user interface may be interacted with (e.g., pressed) to lower the window shade (e.g., a motor of the window covering expands the shade, thereby lowering the bottom rail) a desired distance. The down arrow of the user interface may be able to adjust the position of the window covering upward if needed. The down arrow (or other user interface control) may be interacted with, such as by being held down a predetermined amount of time, to set the bottom limit of the window covering. Henceforth, when the window covering is lowered/opened, the window covering will automatically stop lowering/opening when the set bottom limit is reached.

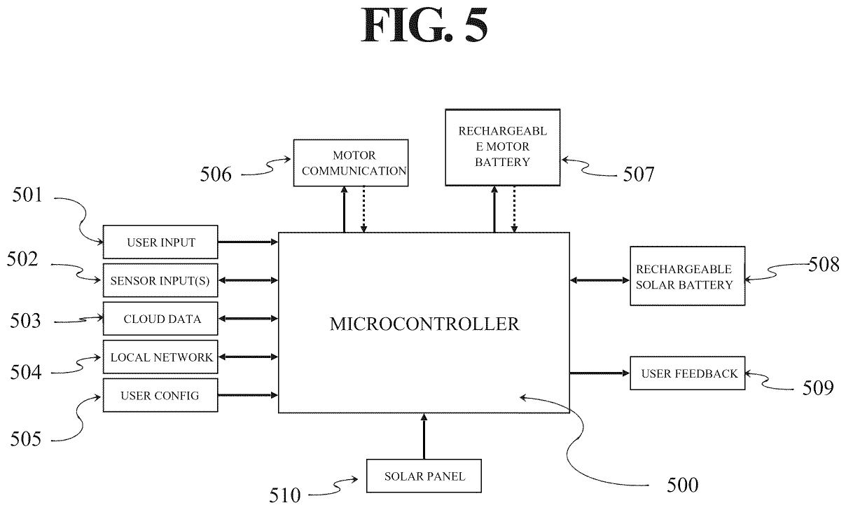

FIG. 5 illustrates example circuit diagram for a microcontroller 500 that may be included in a rail of a window covering disclosed herein. The microcontroller 500 interconnects user input 501 such as buttons, switches and capacitive touch controllers to allow the user to control (raise, lower, stop) or set preferences (disable/enable dynamic shading) and other options. Additionally, a user can modify a user config 505 using a network connected device (e.g., smart phone, virtual assistant) to set energy savings preferences on the dynamic shade. User input 501 may also come from wireless interfaces such as IR, RF, Wi-Fi, Bluetooth which may be initiated by remote control or smart phone or other wireless device or controller. Cloud data 503 and local network 504 devices such as controllers or sensors or smart home devices can also issue controls and/or update dynamic shade settings. Cloud data 503 shall also include weather data or cloud-based firmware updates to the microcontroller 500. Local network 504 devices can also update the firmware of the microcontroller 500. Sensor inputs 502 from integrated sensors in one or both rails of a window covering or elsewhere, such as occupancy, heat, light, proximity, air quality, smoke, gas, level, pressure, accelerometer, compass, glass break, IR and other sensors can further assist the microcontroller 500 to make decisions on raising and lowering the window covering. For instance, the occupancy sensor may be helpful to determine when to and when not to automatically raise a shade. If a user is in the room, they may feel raising the shade automatically is an invasion of their privacy or annoying. There are multiple types of occupancy sensors that may be employed such as convention passive infrared (PIR) or more modern millimeter wave (mmWave). Also, the ability for the shade to dynamically move its sensors may allow for more dynamic algorithms, such as ability to find the actual peak incidence of sun for solar charging or advance occupancy detection or security feature. An accelerometer sensor can also be considered as user input 501 in cases where the user tugs on the rail to indicate they want the window covering to raise or lower or stop. An accelerometer sensor can also be used to determine the stop of the shade when it hits the windowsill.

Other opportunities for energy efficiency optimization and measurement include the ability to measure differential sensor readings such as light, heat and humidity sensors on inside and outside facing sides of the rail to determine things like quality of seal of the window covering or detecting error cases. A common problem with high performing window coverings on single pane windows is water condensation. The integrated humidity sensor can alert a user to a water condensation issue and raise the window covering automatically to remedy or call the issue to a user's attention. A level sensor can indicate when the window covering is not mounted properly or has settled over time. Glass break sensors are suitable for security applications as windows are common entry points for thieves. Gas, smoke and air quality are also helpful indicators of other emergencies a household or business may be facing. IR may be used to support external IR remote control features without the need for wireless pairing. The microcontroller 500 also uses motor communication 506 to understand the state of the motor or set motor settings such as torque, speed or set limits. Motor charge 507 can be used to optimally manage the charge state of the rechargeable motor for maximum lifetime. The solar battery 508 charging and discharging logic is managed by the microcontroller 500. In certain cases, the dynamic shading system will need to communicate feedback to the end user. For this purpose, user feedback 509 is used to provide lighting, sound or voice feedback to let the user know of pending window covering state change(raise/lower) or error or state of charge or something else. The solar battery 508 is connected to the microcontroller 500 and logic inside the microcontroller determines when the solar panel 510 should charge the solar battery 508.

To maintain optimum battery life, the charging logic will determine proper thresholds for when the solar battery should charge the motor battery. When the bottom rail is docked 511 (raised), the logic may check the motor battery's state of charge 512. If the motor battery's state of charge 512 is below a threshold and the solar battery state of charge 513 is above a threshold, then the charge motor battery with solar battery 514 operation should commence. The state machine should check the solar battery state of charge 513 on a time interval to make sure that the solar battery state of charge 513 does not go below threshold. If the solar battery state of charge 513 goes below threshold, then the no charging 515 action should be taken. Also, if the check motor battery state of charge 512 is above threshold, no charging 515 action should be taken.

Note that a window covering may include one or more batteries of other battery type(s). As used herein, the term “rail battery” encompasses any type and number of batteries included in a window covering rail, such as solar charged battery, a battery that receives charge from another source (e.g., a wall socket), a non-rechargeable battery, and/or another battery of suitable type.

### III. Example Embodiments for Battery Arrangement for Motorized Window Covering

As disclosed herein, window coverings are motorized in various embodiments, where the motorized window covering comprises a drive unit, such as a motor, and the power source of the motorized window covering comprises a battery. In some solutions, the battery and/or motor are near an outer edge (e.g., a left or right edge) of a window covering rail. While such a configuration can be utilized in some instances, a weight imbalance and/or inefficiency can result due to the location of such components.

Embodiments disclosed herein overcome these issues. In particular, a battery unit for a headrail type motorized window covering is disclosed herein. The battery unit includes a housing, a battery pack, an input coupling, and an output coupling. An intermediate drive shaft is positioned between and mechanically connects the input coupling to the output coupling. In an embodiment, the intermediate drive shaft has a center of rotation that is offset from that of the input and output couplings. In accordance with examples, the rotational force that operates the movement of the motorized window covering is transferred through the battery unit. In some implementations, the motor is situated on a drive shaft that provides the rotational forces. In this manner, the motorized window covering has improved balancing and efficiency, resulting in an improved overall ease of use (e.g., installation) and operation of the motorized window covering. In addition, since some implementations allow for the motorized window covering to be trimmed (e.g., cut) from one or both ends to allow the motorized window covering to be sized for a particular window, placement of the motor and/or battery near a center of the motorized window covering allow customization to be carried out with little to no impact on the operation of the window covering. For instance, when the left and/or right ends of the headrail type motorized window covering is trimmed, the motor and battery remain unchanged. In other words, in accordance with disclosed techniques, trimming of the window covering can be carried out in a manner such that the window covering operates as intended and remains balanced.

Additional details relating to such techniques are described in greater detail below. It should be noted that the following discussion relating to a battery unit for a motorized window covering can be combined with any disclosure herein. For instance, the battery unit in the discussion that follows can be implemented on any one or more of the foregoing window covering arrangements and/or can be combined with any other techniques related thereto.

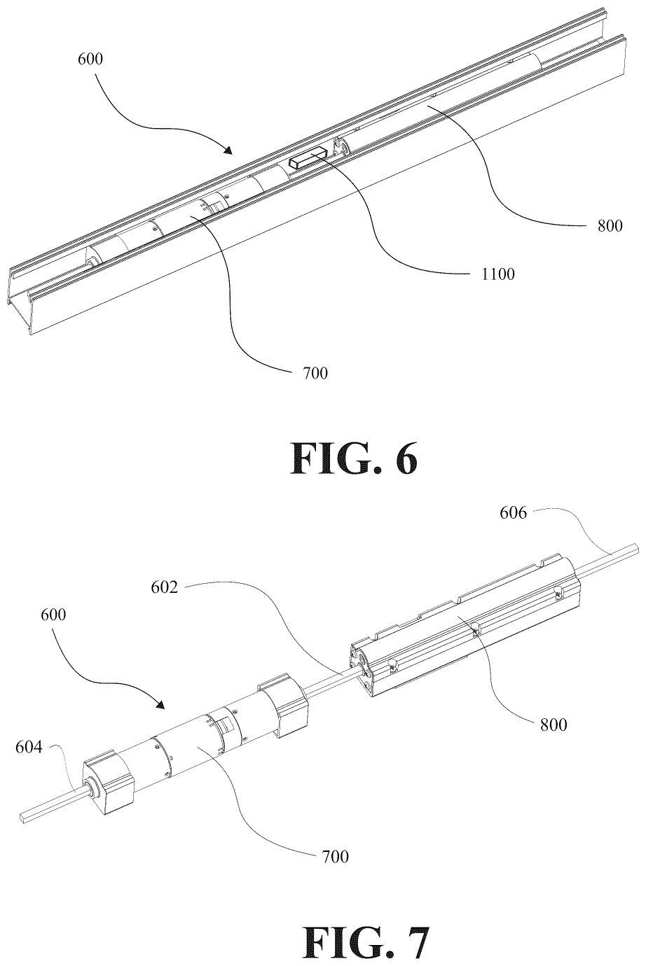

For instance, FIG. 6 depicts a headrail arrangement with a motor and a battery unit, according to embodiments. FIG. 6 depicts a headrail assembly 600. Headrail assembly 600 is an example of a window covering as described herein. For instance, headrail assembly 600 is implemented as top rail 401, as described herein. In various embodiments, headrail assembly 600 comprises any one or more of the features and/or components described herein. As shown in FIG. 6, headrail assembly 600 comprises a motor 700, a battery unit 800, and a microcontroller 1100. Headrail assembly 600 also comprises a headrail that is configured to house motor 700, battery unit 800, and various other components as described herein. In embodiments, the headrail is an example of top rail 401. In examples, headrail assembly 600 is mounted at or near an upper portion of a window opening.

In an embodiment, motor 700 comprises a drive unit configured to generate a rotational motion or force. In examples, motor 700 comprises, or is coupled (e.g., mechanically), to a drive shaft that rotates around an axis. In an embodiment, motor 700 converts electrical energy (e.g., from battery unit 800) into a rotational motion around an axis or a shaft. In one example, motor 700 converts electrical energy into a rotational motion by creating magnetic fields to generate a torque. In example, motor 700 comprises various types of motors, such as a stepper motor configured to generate a controlled or discrete rotational motion in one or more increments, a linear motor, a piezoelectric motor, a voice coil motor (VCM), a servo motor, or other types of motors that can be controlled to generate a desired amount of rotation based on an input.

In an embodiment, battery unit 800 is electrically coupled to motor 700, such that energy stored in battery unit 800 is provided to motor 700 to cause the motor to convert the stored energy into a rotational motion to rotate the drive shaft (e.g., upon a signal received from a user interface or other controller). In an example, the drive shaft is mechanically coupled to motor 700 and/or battery unit 800. In one embodiment, the axis of rotation of the drive shaft is through battery unit 800. For instance, the drive shaft is configured to pass through, and rotate through, an interior portion of battery unit 800. In an embodiment, headrail assembly 600 comprises a window shade or blind (e.g., a fabric) that is configured to be raised or lowered based at least on a rotational movement of the drive shaft. Examples of such features are described elsewhere herein.

In an embodiment, microcontroller 1100 is an example of microcontroller 500. Although not expressly illustrated, headrail assembly 600 comprises one or more other components and/or inputs (e.g., sensor, solar panel, user input, etc.) described elsewhere herein, such that microcontroller 1100 may utilize such features to control the operation of headrail assembly 600.

FIG. 7 depicts another view of headrail assembly 600 with motor 700 and battery unit 800, according to embodiments. In an embodiment, FIG. 7 depicts headrail assembly 600 without the headrail (e.g., top rail) shown in FIG. 6. As shown in FIG. 7, motor 700 (which comprises a motor assembly in examples) and battery unit 800 are interconnected by a drive shaft 602 (or a first central driveshaft). In one implementation, drive shaft 602 is split into multiple segments, where each segment rotates synchronously in tandem with each other. Such an arrangement may be utilized for product fabrication purposes. In other examples, drive shaft 602 comprises a single segment.

In embodiments, drive shaft 602 (as well as other driveshafts described herein) comprises one or more elongated members that is coupled (e.g., at one or more ends) to another component to transfer a rotational movement. For instance, one end of drive shaft 602 is coupled to motor 600, such that drive shaft 602 rotates around an axis when motor 600 generates a rotational force. In some embodiments, drive shaft 602 is coupled directly to motor 600. In other examples, drive shaft 602 is coupled indirectly to motor 600, such as via one or more gears or other components that are configured to transfer a rotational motion from motor 600.

In some embodiments, the axis of rotation of drive shaft 602 is different than an axis of rotation of a rotational force generated by motor 600. Driveshaft 602 comprises any suitable cross-section, such as square, round, oval, rectangular, star-shaped, etc.

As shown in FIG. 7, headrail assembly 600 also comprises a left driveshaft 604 and a right driveshaft 606 (or a second central driveshaft). In examples, left driveshaft 604 and/or right driveshaft 606 are split into multiple segments or comprise a single segment. In an embodiment, left driveshaft 604 is coupled or connected (e.g., mechanically) to motor 700 and rotates when motor 700 is energized. Right driveshaft 606 is coupled indirectly to motor 700 via battery unit 800. In an embodiment, right driveshaft 606 is coupled to a coupling of battery unit 800, such that when motor 700 is energized, a driveshaft within battery unit 800 rotates, thereby causing right driveshaft 606 to rotate.

It should be noted that the terms left and right are relative only, and not intended to be limiting. In addition, the position of motor 700 and battery unit 800 as shown in the drawings are illustrative only, and are not meant to be limiting. Rather, modifications can be made, such as arranging the battery unit to the left and the motor to the right, as would be appreciated by those skilled in the relevant arts.

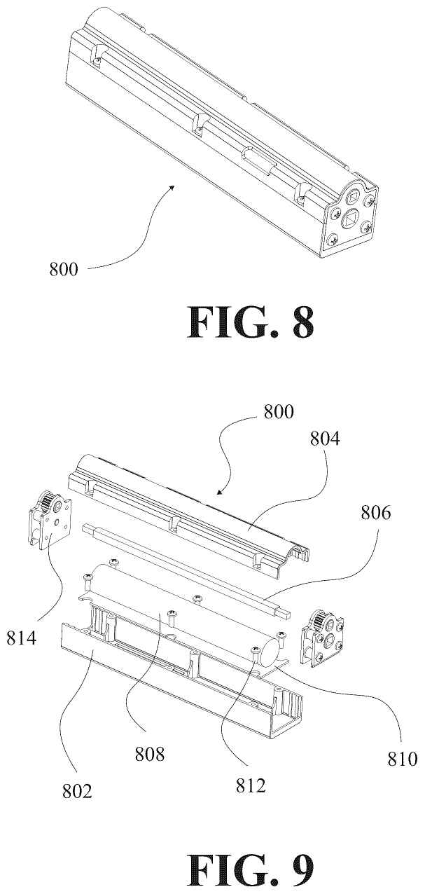

FIG. 8 depicts a view of battery unit 800 in isolation, according to embodiments. In other words, battery unit 800 as shown in FIG. 8 is an example of battery unit 800 shown in FIGS. 6 and 7, except with certain other components removed from the illustration for purposes of clarity. Referring to FIG. 8, battery unit 800 comprises a singular component to be housed in a headrail assembly. For instance, battery unit 800 comprises a module that is able to be installed in various types of window coverings as a single (e.g., integrated) unit. In other embodiments, battery unit 800 is composed of a plurality of units that are assembled together. In examples, battery unit 800 comprises a coupling at each side for coupling a driveshaft. In some examples, the coupling at each side is a recess relative to a plane parallel to the end of battery unit 800. In other embodiments, the coupling comprises a protrusion relative to the plane. In embodiments, the coupling is configured to rotate to transfer a rotational motion (e.g., a motion generated by motor 700).

FIG. 9 depicts an exploded view of battery unit 800, according to embodiments. Referring to FIG. 9, battery unit 800 comprises a bottom shell 802, a top shell 804, an intermediate drive shaft 806, a battery pack 808, a circuit board 810, screws 812 and geared endcaps 814. Geared endcap 814 comprises one or more gears that cause intermediate drive shaft 806 to rotate with an offset center of rotation with respect to the main drive shaft 602 of the headrail assembly. In other words, geared endcaps enable an axis of rotation of intermediate drive shaft 806 to be different than an axis of rotation of drive shaft 602.

In an embodiment, bottom shell 802 and top shell 804 comprise a housing that is configured to house at least a portion of, or all of, intermediate drive shaft 806, battery pack 808, circuit board 810, and/or geared endcaps 814 via one or more fasteners such as screws 812. In an embodiment, bottom shell 802 and top shell 804 are configured to house any other components as described herein, or any other components. In some embodiments, one or more of the components described herein are not housed within the battery unit, such as circuit board 810.

Circuit board 810 comprises circuitry configured to control the storage and/or utilization of energy of battery pack 808. In an embodiment, circuit board 810 comprises a microprocessor that is communicatively coupled to another controller or user interface. In various embodiments, circuit board 810 comprises a controller configured to perform one or more functions described herein relating to window coverings. In some implementations, circuit board 810 comprises a controller to control motor 700. In various examples, control board 810 is configured to cause electrical energy to be stored in battery pack 808, such as by storing energy from a power source (e.g., a solar energy source, an alternating current power source, a direct current power source, another battery pack, etc.) in battery pack 808. In other examples, circuit board 810 is configured to transmit the stored electrical energy to another unit (e.g., microcontroller 1100) to cause the motor to generate a rotational motion from the electrical energy.

In another implementation, circuit board 810 and microcontroller 1100 are integrated into a single controller (e.g., circuit board or other hardware device). In some implementations, circuit board 810 is separate from microcontroller 1100, where circuit board 810 performs certain functions described herein, and microcontroller 110 performs various other functions described herein. In some other embodiments, circuit board 810 is external to battery unit 800. In some embodiments, microcontroller 1100 is internal to battery unit 800. Thus, the illustrations and arrangement of circuit board 810 and/or microcontroller 1100 are not intended to be limiting, and various arrangements are possible as will be appreciated by those skilled in the relevant arts.

Battery pack 808 comprises a battery configured to store electrical energy. When circuit board 810 receives a trigger (e.g., via a user interface or other controller) to cause motor 700 to rotate, battery pack 808 is configured to convert stored energy to electricity that is provided to motor 700, causing motor 700 to rotate.

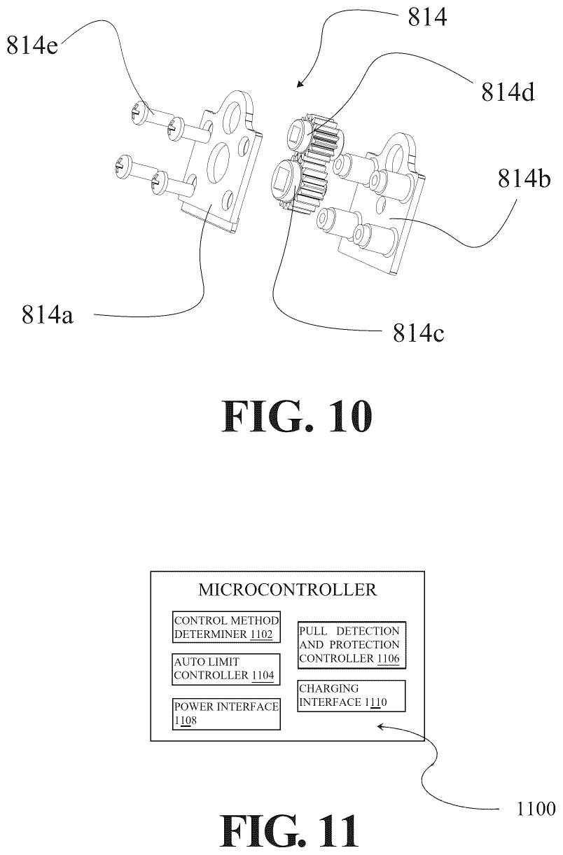

FIG. 10 depicts an exploded view of geared endcap 814, according to embodiments. Referring to FIG. 10, geared endcap 814 comprises an outer cover 814a, an inner cover 814b, a main axis gear 814c, an off axis gear 814d and screws 814e. In an example, geared endcap 814 comprises one end cap (e.g., a left or right end cap) of battery unit 800. Although not shown in FIG. 10, a second geared endcap is similarly configured for the other end of battery unit 800.

In an example, main drive shaft 602 is coupled (e.g., mechanically coupled, such as directly or indirectly) to main axis gear 814c. Main axis gear 814c is coupled with off axis gear 814d. Off axis gear 814d comprises a center portion which comprises a coupling to intermediate drive shaft 806 (e.g., an end thereof). Intermediate drive shaft 806 (or at least a portion thereof) is positioned between main drive shaft 602 and right drive shaft 606. In an embodiment, intermediate drive shaft 806 (or at least a portion thereof) is positioned between an input coupling (e.g., a first one of geared endcaps 814) and an output coupling (a second one of geared endcaps 814) Rotation of main drive shaft 602 causes main axis gear 814c to rotate. Rotation of main axis gear 814c causes off axis gear 814d to rotate, which in turn causes intermediate drive shaft 806 to rotate.

At the other end of battery unit 800, the motion (e.g., the rotations or rotational force) is reversed. For instance, at a similarly configured geared end cap 814 on the other end of battery unit 800, the rotational motion of intermediate drive shaft 806 causes an off axis gear (similar to off axis gear 814d) to rotate, which in turn causes a main axis gear (similar to main axis gear 814c) to rotate, which in turn results in rotation of a right drive shaft 606 (or left drive shaft 604, depending on the arrangement) coupled to the battery unit 800. In other words, at the other end of battery unit 800, a main axis gear transmits the same rotational motion originating from main drive shaft 602. In embodiments, right drive shaft 606 rotates at the same speed and direction as left drive shaft 604.

It should be noted that any one or more of the components described herein can be manufactured in a manner such that the function of various components can be combined into a single component. For instance, main drive shaft 802 can be affixed, or manufactured as a single unit, with main axis gear 814c. Similarly, off axis gear 814d can be manufactured as a single unit with intermediate drive shaft 806. These are only examples, and various other components can be combined together and/or separated without departing from the scope of the disclosure.

In examples, geared endcap 814 (e.g., the entire assembly thereof) is sandwiched between outer cover 814a and inner cover 814b. In an embodiment, geared endcap 814 is affixed together by one or more screws 814e. For instance, one or more screws 814e affix outer cover 814a to inner cover 814b (or vice versa), with the gears therebetween. While screws 814e are shown in FIG. 10, any other type of fastener may be utilized to assemble and/or affix geared endcap 814, including pins, nails, straps, tapes, adhesives, welds, epoxies, etc. Similarly, any other type of fastener may be used in place of screws 812 to assemble and/or affix battery unit 800, as shown at least in FIG. 9.

In an embodiments, such an arrangement allows for a battery unit to be housed or integrated within a headrail type motorized window covering, thereby greatly improving product aesthetics and ease of installation. In addition, the disclosed techniques allow for improved balancing and efficiency of the motorized window covering, resulting in further improvements.

### IV. Additional Window Covering Embodiments

As discussed above, the motorized window covering embodiments may be combined with various other features described herein. For instance, the arrangement and/or structure described with reference to FIGS. 6-10 may be combined and/or integrated with various other features, including but not limited to features described herein with respect to snap on window coverings. In addition, any one of the foregoing embodiments (e.g., snap on window covering embodiments and/or motorized window coverings as described with reference to FIGS. 6-10) may implement one or more of the following additional features.

For instance, FIG. 11 depicts a microcontroller 1100 that can be used for any embodiment. In an embodiment, microcontroller 1100 is an example implementation of microcontroller 500. In examples, microcontroller 1100 utilizes one more inputs/outputs and comprises one or more components described herein (e.g., as described above, such as with reference to FIG. 5) for decision making and controlling the operation of a motorized window covering (including one or more components therein). In some examples, microcontroller 1100 is combined with headrail assembly 600 to control the operation thereof. In other examples, microcontroller is combined with any other window covering assembly as described herein.

As shown in FIG. 11, microcontroller 1100 comprises a control method determiner 1102, an auto limit controller 1104, a pull detection and protection controller 1106, a power interface 1108, and a charging interface 1110. In examples, various features related to certain of the foregoing components are described elsewhere (e.g., with reference to FIG. 5). Additional non-limiting details regarding these components are described below.

In an embodiment, control method determiner 1102 is configured to utilize one or more control methods for controlling the operation (e.g., an upward or downward movement based on energization of a drive unit, such as a motor) of a window covering. In an example, control method determiner 1102 determines a control type associated with operation of the window covering. For instance, a control type indicates the input received for operation of the window covering. In an example, control method determiner 1102 determines whether a control type comprises a user-initiated action (e.g., operation or manipulation of a physical remote control, a user input received through another device such as a smartphone or home automation system, a manual movement of the window covering (e.g., movement of the bottom rail), or other input based on a trigger provided by a user). In another example, control method determiner 1102 determines whether a control type comprises an automation from a network source, such as an automated control of the window covering based on a signal obtained from a cloud, a computer, or other networked device. In embodiments, the automation comprises a control operation based on a time of day, sunset/sunrise, detection of an ambient light level, etc.

In an embodiment, control method determiner 1102 is configured to alter a speed of the motor based on the control type. For instance, if the control type is based on a user-initiated action, control method determiner 1102 is configured to control the window covering (e.g., the motor) at a first speed. In another example, if the control type is based on an automation from a network source, control method determiner 1102 control the window covering at a second speed. In examples, the first speed can be faster or slower than the second speed. In one illustration, the second speed (e.g., operation based on an automation) is slower than the first speed, which generates less noise. Such dynamic operation allows for controlling the motor of a window covering based on an optimization between speed and noise in embodiments, thereby improving the operation of the window covering. For instance, the optimization comprises decreasing the speed (and noise) when the control type is based on an automation, while the optimization comprises increases the speed (and noise) when the control type is based on a control type that is a user-initiated action.

In an embodiment, auto limit controller 1104 is configured to automatically control a motor of the window covering based on a bottom limit (e.g., of a lower rail) being reached or sensed. For instance, where a lower rail reaches a bottom of a window unit (e.g., at or near sill 106), auto limit controller 1104 is configured to cause the motor to automatically stop. For instance, auto limit controller 1104 is configured to cause an interruption in the transfer of energy from the battery unit to the motor to prevent further rotational movement of the motor upon detection that the lower rail reached the bottom.

In an example, auto limit controller 1104 utilizes a sensor input, such as an accelerometer installed in one or more components of the window covering (e.g., in a lower rail, upper rail, etc.), to determine whether a bottom limit has been reached. In another example, auto limit controller 1104 is configured to detect the bottom limit based on the sensor and configure a bottom limit setting that is utilized by a motor controller for subsequent operations of the window covering. In this manner, auto limit controller 1104 is configured to automatically limit a downward movement of a blind or shade based on an input from one or more sensors.

In an embodiment, pull detection and protection controller 1106 is configured to detect whether a shade or blind of a window covering is manually operated. For instance, a manual operation comprises a user pulling on the shade or blind (e.g., based on a pulling force applied to the bottom rail) with a downward force, or pushing up the shade or blind with an upward force. In an embodiment, pull detection and protection controller 1106 detect such manual operations based on sensor input, such as an input from an accelerometer, a position sensor, or other type of sensor.

In an embodiment, pull detection and protection controller 1106 is configured to automatically operate one or more components of the motorized window covering (e.g., by energizing a motor of the window covering) based on a detection of a manual operation. For instance, if pull detection and protection controller 1106 detects that a user is pulling down (or pushing up) on the bottom rail, pull detection and protection controller 1106 is configured to cause the motor of the window covering to be energized to rotate in such a manner that causes a shade or blind of the window covering to be lowered (or raised). In some embodiments, the window covering is lowered until the bottom limit has been reached. In other embodiments, the window covering is raised until an upper limit has been reached (e.g., the window covering is fully retracted). In this manner, pull detection and protection controller 1106 prevents damage to the window covering and minimizes the likelihood that the window covering is pulled off of the window (or frame) on which it is installed. In addition, pull detection and protection controller 1106 also prevents injury or hazard to the user, such as where a user attempts to operate a window covering that they believe is manually operated.

In an example, power interface 1108 comprises a sensor interface configured to select one or more power sources for operation of the window covering. In one example, power interface 1108 determines whether to utilize a built-in battery (e.g., battery pack 808 or any other built in battery as described herein), or an external power source. Based on such a determination, power interface 1108 is configured to operate window covering using the selected power source(s).

In an embodiment, power interface 1108 comprises an interface that enables power to be consumed by one or more external accessories (e.g., devices external to, or separate from, the window covering). For instance, power interface 1108 enables power to be provided from one or more power sources (e.g., battery pack 808, a solar power source, a hardwired power source, etc.) to be provided to another device, such as a light, another window covering, a speaker, a sensor, a home automation device, a smartphone, etc. In an example, the external accessory is coupled to the window covering using an electrical connection, such as Universal Serial Bus (USB), power adapter, wire connectors, pins, etc.

In some implementations, power interface 1108 determines an amount of power to be provided to the one or more external accessories based on various factors, such as the amount of charge available or stored in the power source of the window covering. In some embodiments, power interface 1108 is configured to enable or disable the providing of such power based on one or more other factors, such as a user input.

In an embodiment, charging interface 1110 comprises a solar panel interface for charging a battery, such as battery pack 808 (or any other built in battery). For instance, charging interface 1110 is configured to convert solar energy into an electrical energy that is stored in a battery, such that the battery may consume the stored energy at a later time. In this manner, a motorized window covering may operate based on solar energy, allowing users to avoid cumbersome installations in which a separate (e.g., a hardwired power source) is needed for operation. Additional details regarding the operation and utilization of a solar panel are described elsewhere herein.

In an embodiment, microcontroller 1100 comprises a motor communication unit (e.g., microcontroller utilizes motor communication 506) to automatically cause the motor to change the position of a blind or shade (e.g., by lowering the blind or shade) in response to a battery mode. In an embodiment, microcontroller 1100 is configured to determine or detect a current charge level (e.g., a charge state) of a battery (e.g., battery pack 808). Based on a detection of a charge state, such as a low battery state or mode (e.g., a state in which a current charge level is below a threshold), microcontroller 1100 is configured to automatically cause the blind or shade position to change (e.g., to a lower, or the lowest, position). In an example, such automatic changing of the position facilitates easier charging in some implementations (e.g., by facilitating easier charging from a bottom rail after the blind or shade is lowered).

### V. Conclusion

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described example embodiments, but should be defined only in accordance with the following claims and their equivalents.

What is claimed is:

1. A motorized window covering, comprising:
a housing;
a battery unit;
an input coupling on the battery unit for a first central driveshaft of a headrail of the motorized window covering; and
an output coupling on the battery unit for a second central driveshaft of the headrail of the motorized window covering.

2. The motorized window covering of claim 1, wherein the battery unit is contained within the housing.

3. The motorized window covering of claim 1, wherein the first central driveshaft is mechanically coupled to a motor.

4. The motorized window covering of claim 1, further comprising:
an intermediate drive shaft that is positioned between the input coupling and the output coupling.

5. The motorized window covering of claim 4, wherein the intermediate drive shaft mechanically connects the input coupling and the output coupling.

6. The motorized window covering of claim 5, wherein the input coupling and the output coupling comprise one or more gears.

7. The motorized window covering of claim 1, wherein the intermediate drive shaft has a center of rotation that is offset from a center of rotation of one or more of the input and output couplings.

8. The motorized window covering of claim 4, wherein an axis going through a center of one of the first or second central driveshafts is different than an axis going through a center of the intermediate driveshaft.

9. The motorized window covering of claim 1, wherein the motorized window covering comprises a headrail motorized window covering.

10. The motorized window covering of claim 1, further comprising a microcontroller configured to control one or more components of the motorized window covering.

11. The motorized window covering of claim 1, wherein the microcontroller controls a motor based on a control type, the control type including one or more of a physical remote or an automation from a network source.

12. The motorized window covering of claim 11, wherein the motor is controlled based on an optimization of speed and noise.

13. The motorized window covering of claim 11, wherein the microcontroller is configured to automatically limit a downward movement based on a sensor.

14. The motorized window covering of claim 13, wherein the sensor comprises an accelerometer.

15. The motorized window covering of claim 11, wherein the microcontroller is configured to energize a motor based on a detection of a manual upward or downward operation of a window shade.

16. The motorized window covering of claim 11, wherein the microcontroller comprises a solar panel interface to charge a battery contained in the battery unit.

17. The motorized window covering of claim 11, wherein the microcontroller comprises an interface to select a power source, the power source comprising a battery contained in the battery unit.

18. The motorized window covering of claim 11, wherein the microcontroller comprises an interface to power one or more accessories external to the motorized window covering.

19. The motorized window covering of claim 11, wherein the microcontroller uses a motor communication unit to automatically lower the shade in response to a detection of a low battery state.

20. The motorized window covering of claim 19, wherein the low battery state comprises a charge level of the battery pack that is below a threshold.
